(19) United States
(12) Patent Application Publication
(10) Pub. No.: US 2003/0164023 A1
(43) Pub. Date: Sep. 4, 2003

(54) Method for operating a sensor element

(76) Inventors: Werner Gruenwald, Gerlingen (DE); Bernd Schumann, Rutesheim (DE); Sabine Thiemann-Handler, Stuttgart (DE)

Correspondence Address: KENYON & KENYON, ONE BROADWAY, NEW YORK, NY, 10004, US

(21) Appl. No.: 10/311,945

(22) PCT Filed: May 2, 2002
(86) PCT No.: PCT/DE02/01584

(30) Foreign Application Priority Data
May 4, 2001 (DE) 101 21 771.4

(51) Int. Cl. G01N 31/10; G01N 7/00

(52) U.S. Cl. 73/23.31

(57) ABSTRACT

A method for operating a sensor element (10) for determining at least one gas component of a gas, in particular of an exhaust gas of a combustion engine, is proposed. A measured gas space (35) that is in communication with the gas located outside the sensor element (10) is introduced into the sensor element (10). A first electrode (31) and a second electrode (32) are provided in the measured gas space (35) on an oxygen-ion-conducting solid electrolyte (21), and a third electrode (33) is provided outside the measured gas space (35). The second electrode (32) is electrically connected by the solid electrolyte (21) to the third electrode (33), so that oxygen is pumpable by application of a voltage between the second electrode (32) and the third electrode (33). A lower voltage is present between the second and the third electrode (32, 33) in a first time interval than outside the first time interval, so that under constant external conditions, the oxygen partial pressure in the measured gas space (35) is greater, at least when averaged over the durations, during a first time interval than during a second time interval.

### BACKGROUND OF THE INVENTION

The invention is based on a method for operating a sensor element as defined in the preamble of the independent claim.

A method of this kind for operating a sensor element is known to those skilled in the art and is described, for example, in DE 44 39 901 A1. The sensor element has a measured gas space which is configured as a diffusion channel and in which a first and a second electrode are applied on a solid electrolyte. The measured gas space is in communication with the measured gas located outside the sensor element. The first electrode is positioned in the diffusion channel behind the second electrode in the diffusion direction. The second electrode is coated with a layer that is impermeable to nitrogen oxides (NOₓ). A third electrode is provided on the side of the solid electrolyte opposite the first and second electrodes. The first and third electrodes, and the second and third electrodes, constitute in each case a pump cell. A constant voltage is applied between the second and third electrodes and causes oxygen to be pumped out of the diffusion channel. Since the second electrode is coated with a layer impermeable to NOₓ, the NOₓ is not decomposed at the second electrode and can pass into the gas space in the region of the first electrode. A constant pump voltage, which causes decomposition of NOₓ, at the first electrode and pumps off the oxygen released by the NOₓ decomposition, is applied between the first and third electrodes as well. The NOₓ concentration of the exhaust gas can be determined from the pump current between the first and third electrodes.

DE 100 48 240 also describes a sensor element into which is introduced a measured gas space in which a first, NOₓ-accumulating electrode is positioned. The first electrode is connected in such a way that in a first time interval, NOₓ is accumulated in the first electrode; and in a second time interval, the NOₓ is decomposed by application of a voltage between the first electrode and a third electrode, and the oxygen deriving from the decomposition is pumped off. In addition, a constant oxygen partial pressure is established by a suitable circuit using a pump cell that encompasses a second electrode positioned in the measured gas space, and a Nernst cell in the measured gas space. In particular, the oxygen partial pressure is regulated to the same value during the first and the second time interval.

The methods described above for operating a sensor element are disadvantageous in that the pump current which flows between the first and third electrodes, and from which the NOₓ content of the exhaust gas is determined, is very small at low NOₓ concentrations and cannot be measured with sufficient accuracy. The accuracy for determination of the NOₓ concentration is thus also limited.

In the context of the sensor elements just described, a non-negligible oxygen partial pressure moreover exists in the region of the first electrode, so that in addition to the oxygen deriving from NOₓ decomposition, molecular oxygen in contact with the first electrode must also be pumped off by the first electrode. The pump current therefore contains a contribution that is not correlated with the NOₓ concentration and therefore distorts the measurement result. In the sensor element described above, this distortion of the pump current cannot be avoided by completely or almost completely pumping off the oxygen component of the exhaust gas using the second electrode. This is because, depending on the prevailing temperature and the concentration of the components involved, NOₓ is converted by an equilibrium reaction into N₂ and O₂. The molecular oxygen created by this equilibrium reaction is then pumped off by the second electrode, thereby again distorting the NOₓ measurement.

### ADVANTAGES OF THE INVENTION

In contrast to the existing art, the method according to the present invention for operating a sensor element, having the characterizing features of the first claim, has the advantage that even low concentrations of a gas component can be determined with high accuracy.

For that purpose, the sensor element has a first and a second electrode positioned in a measured gas space. The second electrode forms, together with a third electrode positioned outside the measured gas space, a pump cell with which oxygen can be pumped into or out of the measured gas space. During a first time interval, the voltage present between the second and the third electrode is selected so that the gas component to be analyzed is not decomposed either at the second electrode or as a result of the equilibrium reaction occurring at low oxygen partial pressure in the measured gas space. This ensures that the gas component to be analyzed can reach the region of the first electrode. During a second time interval, a voltage that is higher compared to the first time interval is applied between the second and the third electrode, so that the molecular oxygen O₂ in the measured gas space is completely or almost completely pumped off by the first electrode. The oxygen partial pressure in the measured gas space is thus lower during the second time interval than during the first time interval. This guarantees that when the gas component to be analyzed is determined at the first electrode, the quantity of molecular oxygen is negligible compared to the quantity of the gas component to be analyzed.

The features set forth in the dependent claims make possible advantageous developments of the gas sensor described in the independent claims.

If, during the first time interval, a potential that lies below the potential necessary for decomposition of the gas component to be analyzed is present at the first electrode, the gas component to be analyzed can then build up in the vicinity of the first electrode. During the second time interval, the first electrode is set to a potential that brings about decomposition of the gas component to be analyzed, so that the gas component to be analyzed that has built up in the vicinity of the first electrode is decomposed. The concentration of the gas component to be analyzed can then be determined by pumping off the oxygen released by decomposition using the first electrode, and determining the pump current. It is also conceivable to determine the concentration of the gas component to be analyzed by measuring the oxygen partial pressure, for example using a Nernst cell.

If, in addition, a means for accumulating the gas component to be analyzed, for example an accumulating material, is provided in or on the first electrode or in the vicinity of the first electrode, the gas component to be analyzed that comes into the vicinity of the first electrode during the first time interval can then be absorbed into the accumulating material in controlled fashion. When the oxygen partial pressure is decreased during the second time interval by pumping of the measured gas space using the second electrode, decomposition of the gas component to be analyzed that is accumulated in said material, for example due to the low oxygen partial pressure or by contact with the second electrode, is thus prevented. This ensures that all of the gas component to be analyzed that has built up in the accumulating material during the first time interval can be decomposed in the second time interval. As a result, even low concentrations of the gas component to be analyzed can be determined. This also ensures that contributions to the measured signal that do not derive from pumping off of the oxygen resulting from decomposition of the gas component to be analyzed are negligible.

For purposes of the invention, a “means for accumulating the gas component to be analyzed” is also to be understood as a material in which the gas component to be analyzed is accumulated, for example by chemical adsorption, in the form of a chemical compound at least partially containing the gas component to be analyzed.

Advantageously, the pump voltage between the second and the third electrode is selected so that limit current conditions are achieved. Limit current conditions are present when, at least approximately, all of the molecular oxygen coming into the vicinity of the first electrode is pumped off, so that an increase in pump voltage causes no increase, or only an insignificant increase, in the pump current, since the pump current depends only on the inflow of the relevant gas constituents as limited by the geometry of the sensor element, in particular by the diffusion resistance. If the second electrode is designed so that limit current conditions are achieved in the measured gas space upon application of a suitable voltage between the second and third electrodes during the second time interval, the oxygen partial pressure can then be dependably established independently of the oxygen partial pressure in the exhaust gas.

The second electrode is preferably positioned so that it is in contact with a region of the measured gas space located between the diffusion resistance and the first electrode. As a result, the oxygen diffusing out of the exhaust gas into the measured gas space can arrive at the first electrode only via the measured gas space in the vicinity of the second electrode. This ensures that the oxygen diffusing into the measured gas space can be pumped off by the second electrode before reaching the first electrode.

The gas component to be analyzed can be, for example, NOₓ; the solid electrolyte can be ZrO₂ doped with Y₂O₃. For NOₓ accumulation, oxides of the fifth subgroup, for example V₂O₅, or a mixture of oxides of the fifth subgroup, as well as barium, cerium, or magnesium in the form of nitrates, oxides, or carbonates, or a mixture of the aforesaid compounds, have proven suitable.

The process of accumulating the gas component to be analyzed during the first time interval, and of determining the gas component to be analyzed during the second time interval, can be effectively assisted if, by way of a temperature regulation system, the temperature present at the first electrode during the first time interval is lower than during the second time interval, since at lower temperatures, e.g. below 550 degrees Celsius, accumulation of NOₓ occurs particularly effectively, especially in the form of nitrates.

### DRAWING

The invention will be explained with reference to the drawings and the description below.

FIG. 1 is a longitudinal section of a sensor element that is operated in accordance with the method according to the present invention.

FIG. 2 is a sectioned depiction of the sensor along line II-II in FIG. 1.

FIGS. 3a through 3d are schematic depictions of the changes over time in the electrical voltages and currents occurring in the context of an exemplified embodiment of the method according to the present invention for operating the sensor element.

### DESCRIPTION OF THE EXEMPLARY EMBODIMENT

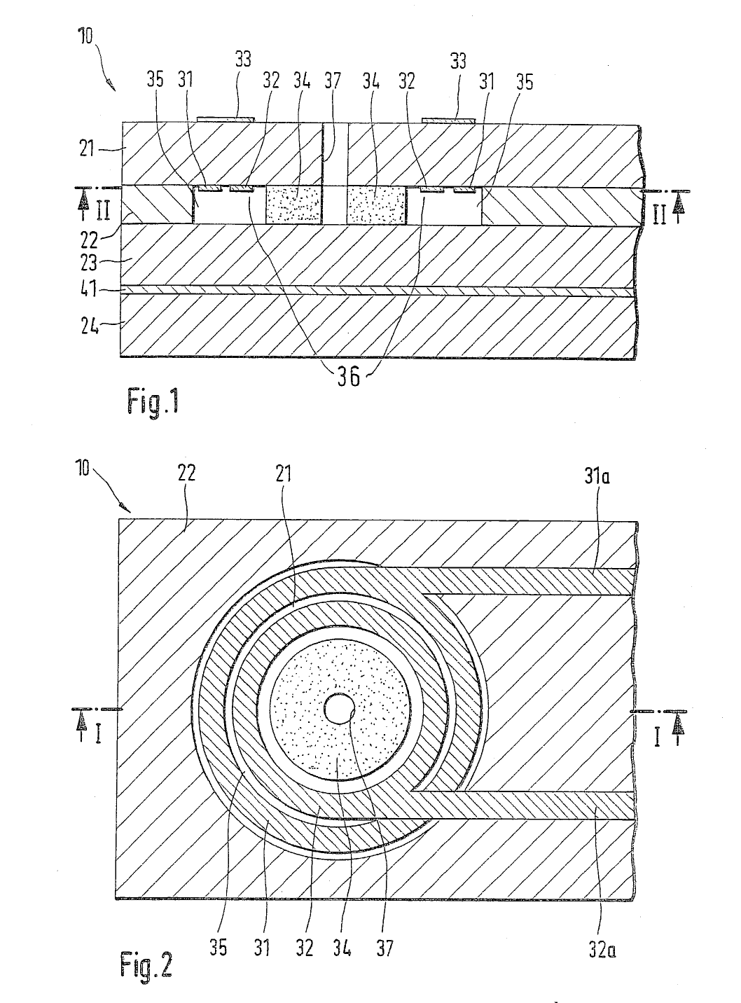

FIG. 1 and FIG. 2 show a portion of a sensor element 10 that is operated in accordance with the method according to the present invention. Sensor element 10 has a first, a second, a third, and a fourth solid electrolyte layer 21, 22, 23, 24. A measured gas space 35 that is in communication with an exhaust gas located outside sensor element 10 is introduced into second solid electrolyte layer 22. The exhaust gas can enter measured gas space 35 through a gas entry opening 37 present in first electrolyte layer 21, and a diffusion resistance 34.

An annular first electrode 31 having an inlet conduit 31a, and an annular second electrode 32 having an inlet conduit 32a, are provided in measured gas space 35, second electrode 32 being positioned between hollow-cylindrical diffusion resistance 34 and first electrode 31. Inlet conduit 32a of second electrode 32 is electrically insulated from first electrode 31 by an insulation layer (not depicted). A third electrode 33 having an inlet conduit (not depicted) is applied on the side of first solid electrolyte layer 21 facing away from first and second electrodes 31, 32. Third electrode 33 can be covered by a porous protective layer (not depicted). A heating apparatus 41 is provided between third and fourth solid electrolyte layers 23, 24 in order to heat the sensor element.

First, second and third electrodes 31, 32, 33 contain platinum and a ZrO₂ component as a supporting structure, and are of porous configuration. Solid electrolyte layers 21, 22, 23, 24 contain ZrO₂ doped with Y₂O₃. First electrode 31 furthermore contains a material that accumulates NOₓ. An oxide of the fifth subgroup, in particular V₂O₅, or a mixture of oxides of the fifth subgroup, is suitable for this. In an alternative embodiment of the invention, the NOₓ-accumulating material can be made of barium and/or cerium and/or magnesium in the form of nitrates, oxides, or carbonates. The NOₓ-accumulating material can be uniformly distributed in first electrode 31, or can be positioned on or in first electrode 31 as an additional porous layer.

First and third electrodes 31, 33, and the region of first solid electrolyte layer 21 positioned between the two electrodes 31, 33, constitute a first pump cell. Second and third electrodes 32, 33, and the region of first solid electrolyte layer 21 positioned between the two electrodes 32, 33, constitute a second pump cell.

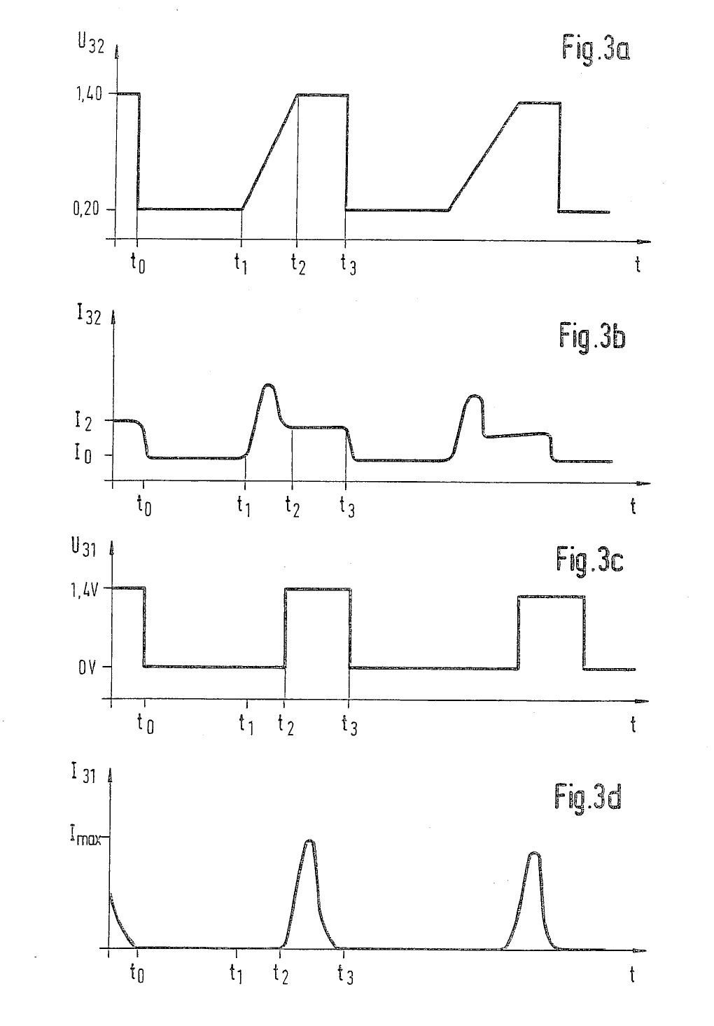

FIGS. 3a and 3b depict curves for pump voltage U₃₂ and pump voltage I₃₂ of the second pump cell, and FIGS. 3c and 3d depict curves for pump voltage U₃₁ and pump current I₃₁ of the first pump cell. During a first time interval that extends from t₀ to t₁, a pump voltage of 0.2 V is applied to the second pump cell, resulting in a pump current I₀ so that oxygen is pumped out of measured gas space 35. The oxygen partial pressure in measured gas space 35 is then as a rule, i.e. at the oxygen partial pressures usually occurring in the exhaust gas, above 10⁻³ bar, so that at the temperatures which usually occur, NOₓ decomposition due to an equilibrium reaction resulting from an oxygen partial pressure below 2*10⁻⁴ bar does not occur. NOₓ can thus reach first electrode 31. No voltage is applied to the first pump cell during the first time interval, so that NOₓ builds up in the NOₓ-accumulating material.

During a second time interval that extends from t₁ to t₃, the voltage at the second pump cell is increased to 1.4 V. The voltage increase can be accomplished abruptly, or can extend over a certain time interval. At a time t₂ within the second time interval, the voltage increase results in the attainment of limit current conditions at which a pump current I₂ flows and at which the oxygen partial pressure in measured gas space 35, at the oxygen partial pressures usually occurring in the exhaust gas, decreases to less than 2*10⁻³⁰ bar (at 700 degrees Celsius).

At the beginning of the second time interval before limit current conditions are attained, the pump current can briefly rise to a value greater than I₂, since the molecular oxygen present in measured gas space 35 is being pumped off. When limit current conditions are present, a voltage of approximately 1.4 V is then applied to the first pump cell, thereby decomposing the NOₓ accumulated in first electrode 31. The oxygen released upon decomposition is pumped off by the first pump cell. From the pump current that flows in this context, the NOₓ concentration in the exhaust gas can be ascertained. The molecular oxygen deriving from the exhaust gas is almost completely pumped off by the second pump cell in the second time interval, and therefore makes at most a negligible contribution to the pump current of the first pump cell.

In an embodiment of the invention, sensor element 10, in particular in the region of first electrode 31, can be regulated by heating apparatus 41 to a temperature in the range of 400 to 600 degrees Celsius, preferably 500 degrees Celsius, during the first time interval; and to a temperature of 600 to 900 degrees Celsius, preferably 780 to 850 degrees Celsius, for example 800 degrees Celsius, during the second time interval.

The NOₓ concentration can be determined in a manner known to one skilled in the art, for example by integrating the pump current flowing during the second time interval or by ascertaining the maximum current Iₘₐₓ flowing during the second time interval.

In the context of the exemplified embodiment described here, the duration of the first time interval is in the range from 0.2 to 20 seconds, preferably 2 seconds; and the duration of the second time interval is in the range from 0.1 to 2 seconds, preferably 1 second. Limit current conditions are typically attained no later than 0.5 second after the beginning of the second time interval.

If an oxide of the fifth subgroup, in particular V₂O₅, or a mixture of oxides of the fifth subgroup, is used as the NOₓ-accumulating material, the first time interval then preferably lasts 1 second and the second time interval 0.5 second. If the NOₓ-accumulating material contains as the essential component barium and/or cerium and/or magnesium in the form of nitrates, oxides, or carbonates, or a mixture of the aforesaid compounds, the first time interval then preferably lasts 5 seconds and the second time interval 0.5 second.

In an alternative embodiment of the invention that is not depicted, a fourth electrode is provided that is electrically connected to the first electrode via a solid electrolyte and forms an electrochemical cell. The fourth electrode can, for example, like third electrode 33, be positioned on an external surface of sensor element 10 or in a reference gas space. If the fourth electrode is positioned in a reference gas space, first electrode 31, the fourth electrode, and a solid electrolyte positioned between these two electrodes can be driven by an external circuit as a Nernst cell. In this case the oxygen liberated by decomposition supplies, directly to first electrode 31, a signal from which the NOₓ concentration can be ascertained.

The method according to the present invention is not suitable only for detection of the concentration of NOₓ. It can also be used to detect, for example, CO₂ or SO₂ using the same accumulating materials.

What is claimed is:

1. A method for operating a sensor element (10) for determining at least one gas component of a gas, in particular of an exhaust gas of a combustion engine, comprising a measured gas space (35), introduced into the sensor element (10), that is in communication with the gas located outside the sensor element (10), a first electrode (31) and a second electrode (32) being provided in the measured gas space (35) on an oxygen-ion-conducting solid electrolyte (21), and a third electrode (33) being provided outside the measured gas space (35), and oxygen being pumpable by application of a voltage between the second electrode (32) and the third electrode (33), wherein at least one predefined first time interval is provided; and a lower voltage is applied between the second and the third electrode (32, 33) in the first time interval than outside the first time interval.

2. The method as recited in claim 1, wherein the voltage present in the first time interval between the second and the third electrode (32, 33) is selected so that under constant external conditions, the oxygen partial pressure in the measured gas space (35) is greater during the first time interval than outside the first time interval.

3. The method as recited in claim 1 or 2, wherein a means for accumulation of the gas component to be analyzed is provided in the vicinity of the first electrode (31) and/or in the first electrode (31).

4. The method as recited in claim 3, wherein the means for accumulation of the gas component to be analyzed is a material accumulating the gas component.

5. The method as recited in claim 3 or 4, wherein the gas component to be determined is accumulated by chemical adsorption in the form of a chemical compound at least partially containing the gas component to be analyzed, or by physical adsorption.

6. The method as recited in at least one of the preceding claims, wherein during the first time interval, there exists at the first electrode (31) a potential at which the gas component to be analyzed is not decomposed or is only slight decomposed; and during a predetermined second time interval located outside the first time interval, there exists at the first electrode (31) a potential by which the gas component to be analyzed is decomposed.

7. The method as recited in at least one of the preceding claims, wherein the voltage between the second (32) and the third electrode (33) is selected so that the gas component to be analyzed is not decomposed during the first time interval at the second electrode (32) and can arrive at the first electrode (31); and during the second time interval, the molecular oxygen present at the first electrode (31) is negligible compared to the oxygen deriving from decomposition of the gas component to be analyzed.

8. The method as recited in at least one of the preceding claims, wherein during the second time interval, the pump voltage between the second and the third electrode (32, 33) is selected so that limit current conditions exist.

9. The method as recited in at least one of claims 3 through 8, wherein within the second time interval, at least the majority of the gas component to be analyzed that has accumulated in the first electrode (31) or in the vicinity of the first electrode (31) is decomposed, the oxygen released upon decomposition being pumped off by the first electrode (31) and the concentration of the gas component to be analyzed being ascertained on the basis of the pump current.

10. The method as recited in claim 8 or 9, wherein during the second time interval, the potential at the first electrode bringing about decomposition of the gas component to be analyzed is not applied until limit current conditions exist.

11. The method as recited in at least one of the preceding claims, wherein the method steps occurring in the first and the second time interval are utilized in recurring time intervals.

12. The method as recited in at least one of the preceding claims, wherein the oxygen partial pressure during the second time interval is at least intermittently less than 10⁻¹⁴ bar.

13. The method as recited in at least one of the preceding claims, wherein in the first time interval a voltage in the range from 0.1 to 0.25 V, preferably 0.2 V, is present between the second and the third electrode (32, 33), and a voltage in the range from 0 to 0.1 V, preferably 0 V, is present between the first and the third electrode (31, 33).

14. The method as recited in at least one of the preceding claims, wherein in the second time interval, at least while limit current conditions exist, a voltage of 1.2 to 1.5 V, preferably 1.4 V, is present between the first and the third electrode (31, 33).

15. The method as recited in at least one of the preceding claims, wherein in the second time interval, at least intermittently and in particular in order to establish limit current conditions, a voltage of 0.8 to 1.5 V, preferably 1.4 V, is present between the second electrode (32) and the third electrode (33).

16. The method as recited in at least one of the preceding claims, wherein the partial pressure of the gas component to be analyzed is ascertained by integrating the pump current flowing through the first electrode (31) during the second time interval.

17. The method as recited in at least one of claims 1 through 15, wherein the partial pressure of the gas component to be analyzed is ascertained by way of the maximum pump current flowing through the first electrode (31) during the second time interval.

18. The method as recited in at least one of the preceding claims, wherein the first time interval lasts 0.2 to 20 seconds, preferably 2 seconds, and the second time interval lasts 0.1 to 2 seconds, preferably 0.5 second.

19. The method as recited in at least one of the preceding claims, wherein the second electrode (32) is in contact with a region (36) of the measured gas space (35) located between the diffusion resistance (34) and the first electrode (31).

20. The method as recited in at least one of the preceding claims, wherein the third electrode (33) is in contact with the exhaust gas located outside the sensor element (10), or is in contact with a reference gas.

21. The method as recited in at least one of the preceding claims, wherein a further electrode that is in contact with a reference gas is provided.

22. The method as recited in at least one of the preceding claims, wherein the first electrode (31) and the third electrode (33), and the solid electrolyte positioned between the first and third electrodes (31, 33), constitute a pump cell.

23. The method as recited in claim 21, wherein the first electrode (31) and the further electrode, and the solid electrolyte positioned between the first electrode (31) and the further electrode, constitute a pump cell.

24. The method as recited in at least one of the preceding claims, wherein the gas component to be analyzed is an oxygen compound, for example NOₓ and/or CO₂ and/or SO₂.

25. The method as recited in at least one of the preceding claims, wherein the first electrode (31) contains an oxide of the fifth subgroup, in particular V₂O₅, or a mixture of oxides of the fifth subgroup; and the solid electrolyte (21) contains ZrO₂ doped with Y₂O₃.

26. The method as recited in claim 25, wherein the length of the first time interval is 0.5 to 3 seconds, preferably 1 second, and the length of the second time interval is 0.1 to 1 second, preferably 0.5 second.

27. The method as recited in at least one of the preceding claims, wherein the first electrode (31) contains barium and/or cerium and/or magnesium in the form of nitrates, oxides, or sulfates.

28. The method as recited in claim 27, wherein the length of the first time interval is 3 to 10 seconds, preferably 5 seconds, and the length of the second time interval is 0.1 to 2 seconds, preferably 0.5 second.

29. The method as recited in at least one of the preceding claims, wherein a means for temperature regulation is provided; the means for temperature regulation encompasses a heating apparatus (41); and during the first time interval, there exists at the first electrode (31) a lower temperature than during the second time interval.

30. The method as recited in claim 29, wherein at the first electrode, during the first time interval a temperature of 400 to 600 degrees Celsius, preferably 500 degrees Celsius, is established, and during the second time interval a temperature of 600 to 900 degrees Celsius, preferably 780 to 850 degrees Celsius, is established.
